(19) United States
(12) Patent Application Publication
(10) Pub. No.: US 2025/0243910 A1
(43) Pub. Date: Jul. 31, 2025

(54) UNIVERSAL JOINT BEARING AND UNIVERSAL JOINT CROSS

(71) Applicant: AKTIEBOLAGET SKF, GOTEBORG (SE)

(72) Inventors: Norbert HUHN, Schweinfurt (DE); Manfred MATTES, Kolbingen (DE); Stefanie SEUFERT, Rothhausen (DE); Juergen BARTHELME, Würzburg (DE)

(21) Appl. No.: 19/035,104

(22) Filed: Jan. 23, 2025

(30) Foreign Application Priority Data
Jan. 30, 2024 (DE) 102024200802.8

(51) Int. Cl. F16D 3/205; F16D 3/202

(52) U.S. Cl. CPC F16D 3/2057; F16D 2003/2023; F16D 2300/08

(57) ABSTRACT

A universal joint bearing includes a trunnion, a cup, rolling elements rotatably supporting the cup relative to the trunnion, and at least one seal for sealing a space between the trunnion and the cup. The cup has a substantially cylindrical surface, which is a part of a radially outer surface of the universal joint bearing. All of the rolling elements of the universal joint bearing are arranged in a certain number of rows of rolling elements. A sum of the maximum axial lengths of all the rows of rolling element divided by the sum of the maximum axial length of the substantially cylindrical surface and the maximum axial length of a radially outer surface of the at least one seal, which is another part of the radially outer surface of the universal joint bearing, is between 0.6 and 0.75.

### CROSS-REFERENCE

This application claims priority to German patent application no. 102024200802.8 filed on Jan. 30, 2024, the contents of which are fully incorporated herein by reference.

### BACKGROUND OF THE INVENTION

The present invention relates to bearings, and more particularly to universal joint bearings and a universal joint crosses.

German patent applications nos. DE 10 2020 205 653 A1, DE 10 2021 206 412 A1 and DE 10 2019 208 775 A1 each disclose a universal joint bearing comprising a trunnion, a cup, rolling elements which rotatably support the cup relative to the trunnion, and a seal which seals a space between the trunnion and the cup. The cup has an at least substantially cylindrical surface which is a part of a radially outer surface of the universal joint bearing and all rolling elements of the universal joint bearing are arranged in a certain number of rows of rolling elements.

### SUMMARY OF THE INVENTION

The present invention is a universal joint bearing comprising a trunnion, a cup, rolling elements which rotatably support the cup relative to the trunnion, and at least one seal which seals a space between the trunnion and the cup, wherein the cup has an at least substantially cylindrical surface which is a part of a radially outer surface of the universal joint bearing, wherein all rolling elements of the universal joint bearing are arranged in a certain number of rows of rolling elements.

It is proposed that a sum of the maximum axial lengths of all rolling element rows divided by the sum of the maximum axial length of the at least substantially cylindrical surface and the maximum axial length of the radially outer surface of the at least one seal, which is a part of the radially outer surface of the universal joint bearing, is between 0.6 and 0.75. As used in the present disclosure, “axial” refers to an axial direction of the trunnion and “radial” refers to radial directions of the trunnion. With this structure, a very efficient construction is achieved. In particular, a good sealing effect of the seal together with a very compact construction of the universal joint bearing in the axial direction of the trunnion and a high dynamic carrying capacity of the universal joint bearing can be achieved.

In particular, adjacent to the substantially cylindrical surface there is no further substantially cylindrical surface of the cup located, which is a part of the radially outer surface of the universal joint bearing.

Preferably, a first rigid part of the seal comprises, in an axial section, a first arm and at least one second arm, which are connected by an intermediate part of the first rigid part, wherein the first arm and the second arm extend from the intermediate part and toward the rolling elements. Thereby, a compact construction of the universal joint bearing in the axial direction together with a good sealing performance of the seal can be achieved.

Preferably, the first rigid part is made of a metallic material.

Moreover, it is proposed that a sealing lip of the seal abuts against a radially outer surface of the second arm. Through this arrangement, a compact axial construction of the universal joint bearing can be achieved, since the sealing lip doesn't have to contact the trunnion.

Preferably, the cup includes a bottom with a recess and the trunnion extends into the recess, wherein the universal joint bearing comprises a first row of the rolling elements, which is directly adjacent to the bottom, wherein the first row of rolling elements comprises at least one rolling element with a running surface, which has contact with the trunnion along its complete axial extension. Thereby, a high dynamic carrying capacity of the universal joint bearing can be achieved.

Furthermore, it is suggested that the cup comprises a bottom with a first elevation and at least a second elevation, and the universal joint bearing comprises a row of the rolling elements, which is directly adjacent to the bottom, wherein this row of rolling elements comprises rolling elements, which contact the first and the second elevation directly. Through this structure, a lubricant, which can be located between the two elevations, is able to reach the row of rolling elements easily, and thus low friction during the movement of the rolling elements can be achieved.

Preferably, the trunnion includes, in an axial region of the seal, at most two surface regions, which each have a shape of a circular cylinder barrel. In particular, an axial region of the seal is a region which is located between a first plane in the mathematical sense and a second plane in the mathematical sense, wherein both planes touch the seal and are parallel to each other and don't intersect and always have the same distance from each other, wherein the complete seal is located between the planes, wherein the planes are orthogonal to an axial direction of the trunnion. Thereby a compact axial construction can be reached.

Furthermore, it is proposed that the universal joint bearing comprises a disc, which is located between the trunnion and at least a part of the bottom of the cup and which comprises grooves on two opposing sides. Through this, an easy assembly of the universal joint bearing can be achieved. In particular, after the disk is put on the bottom of the cup, lubricant can easily be pressed through a central hole of the disk into the grooves of the side of the disc, which faces the bottom. In particular, incorrect assembly of the disk can be avoided because the design of the two sides of the disk may be identical.

Moreover, a universal joint cross with a universal joint bearing as described above is suggested.

Preferably, the universal joint cross comprises a cruciform component, which comprises the trunnion, and twice the distance between the center of mass of all the rolling elements of the universal joint bearing and the center of mass of the cruciform component divided by the maximum outer diameter of the cup is less than 2.23 and greater than 1.8, in particular less than 2.2 and greater than 1.9. Through this, a compact design of the universal joint cross can be achieved, which allows at the same time the capability to withstand relatively high forces.

Moreover, it is proposed that the universal joint cross comprises a cruciform component, which comprises the trunnion, and the dynamic carrying capacity of the universal joint bearing divided by twice the distance between the center of mass of all the rolling elements of the universal joint bearing and the center of mass of the cruciform component is greater than 0.6 kN/mm and less than 0.9 kN/mm. Thereby, a compact design of the universal joint cross together with the capability to withstand relatively high forces and torques can be reached.

### BRIEF DESCRIPTION OF THE SEVERAL VIEWS OF THE DRAWINGS

Further advantages can be seen in the following description of the drawings. Examples of embodiments of the invention are shown in the drawings. The drawings, the description and the claims contain numerous features in combination. The skilled person will expediently also consider the features individually and combine them to form useful further combinations.

FIG. 1 shows a partial section of a universal joint cross with a universal joint bearing according to the invention;

FIG. 2 shows a partial axial section through the universal joint bearing;

FIG. 3 shows a partial axial section through a part of the universal joint bearing with a sealing;

FIG. 4 shows a perspective view of an alternative embodiment of a rigid part of the sealing;

FIG. 5 shows a detail of FIG. 4;

FIG. 6 shows a different perspective view of the rigid part of FIG. 4;

FIG. 7 shows a detail of FIG. 6; and

FIG. 8 shows a perspective view of a disk of the universal joint bearing.

### DETAILED DESCRIPTION OF THE INVENTION

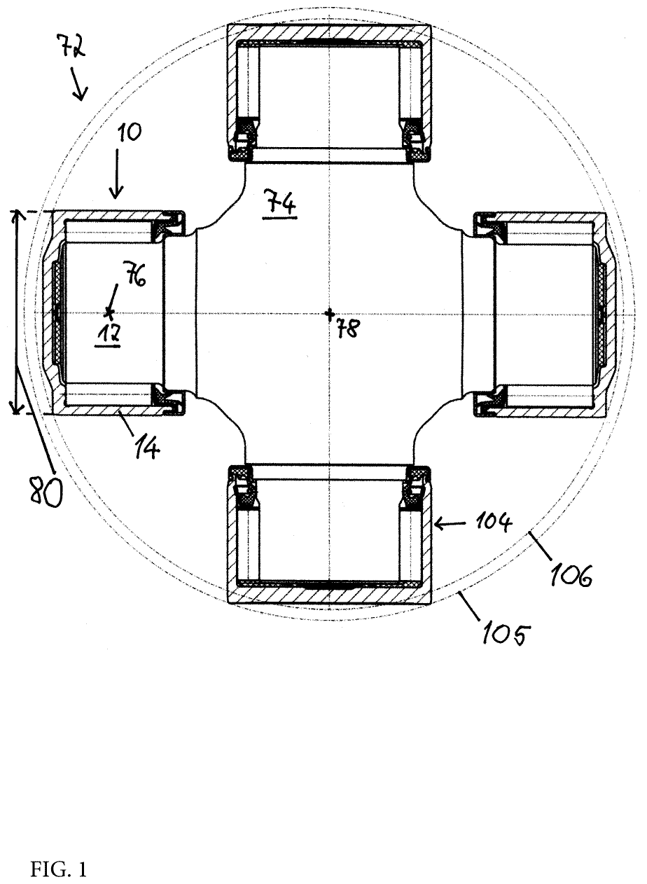

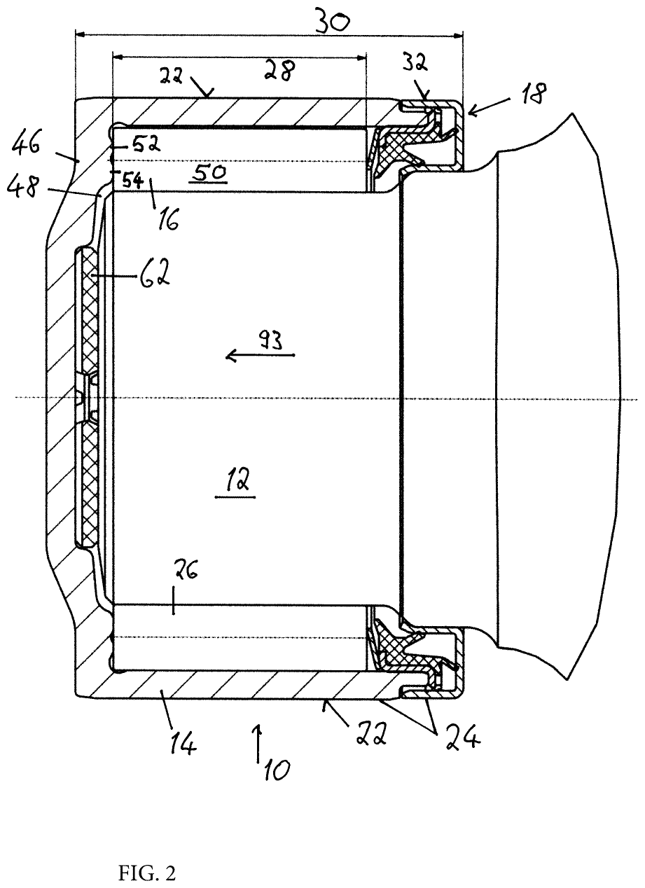

FIG. 1 depict a universal joint cross 72 with a universal joint bearing 10. The universal joint bearing 10 comprises a trunnion 12, a cup 14 and a plurality of rolling elements 16, which support the cup 14 rotatably relative to the trunnion 12 (FIG. 2). Moreover, the universal joint bearing 10 comprises a seal 18, which is configured to seal a space 20 between the trunnion 12 and the cup 14. The cup 12 has a substantially cylindrical surface 22. Alternatively, the surface 22 can be entirely cylindrical. The surface 22 is a part of a radially outer surface 24 of the universal joint bearing 10. Preferably, all the rolling elements 16 are arranged in one row 26 of the rolling elements 16. Alternatively, there may be more than one row of rolling elements.

Further, the maximum axial length 28 of the row 26 divided by the sum 30 of the maximum axial length of the surface 22 and the maximum axial length of the entire radially outer surface 32 of the seal 18, which is a part of the radially outer surface 24 of the universal joint bearing 10, is between 0.6 and 0.75. Therefore, the rolling elements 26 are located nearer or more proximal to a center of mass 78 of the cross 72 than in the prior art, which means that higher or greater forces may be applied to the cup 14 while transmitting the same rotational torque as similar prior art devices.

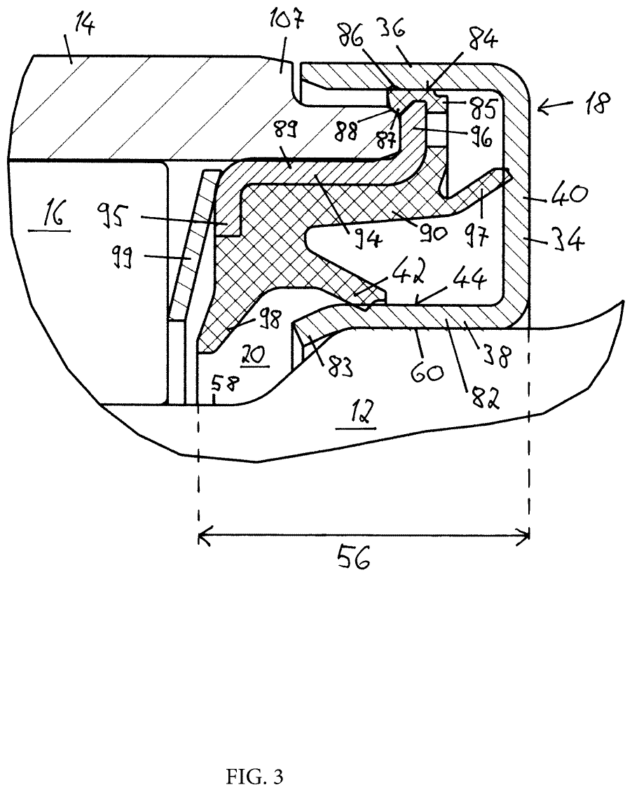

A first rigid part 34 of the seal 18 includes, in an axial section, a first arm 36 and a second arm 38, which are connected by an intermediate part 40 of the first rigid part 34 (FIG. 3). The first rigid part 34 may be made of a metallic material. The first arm 36 and the second arm 38 extend from the intermediate part 40 and toward the rolling elements 16. A sealing lip 42 of the seal 18 abuts against a radially outer surface 44 of the second arm 38. The second arm 38 abuts against the trunnion 12. More specifically, the first rigid part 34 is fixed on the trunnion 12 by a press fit. The seal 18 includes a second rigid part 89, which is fixed to a radially inner surface of the cup 14 by a press fit between an intermediate part 94 of the second rigid part 89 and the cup 14. The second rigid part 89 can be made from a metallic material. The second rigid part 89 includes a first arm 95, which protrudes radially inwardly from the intermediate part 94.

Furthermore, the second rigid part 89 includes a second arm 96, which extends radially outwardly from the intermediate part 94, and which abuts against a face side of the cup 14. Two elastomeric elements 85, 90 are fixed to the second rigid part 89. More specifically, the elastomeric elements 85, 90 are bonded or molded onto the part 89. Only one sealing lip 42 abuts against the second arm 38. The sealing lip 42 is a part of the elastomeric element 90 and abuts against a radially outer surface 44 of the second arm 38. The trunnion 12 is free from any direct contact with any sealing lip.

The second arm 38 includes a first part 82, which is in direct contact with the intermediate part 40, and a second part 83, which is angled relative to the first part 82. When the first rigid part 34 is assembled and fixed to the cup 14, the first rigid part 34 is pushed axially towards the cup 14 and through this the second part 83, which is angled, forces the sealing lip 42 to move radially outwardly in order to exert a certain pressure on the second arm 38.

The elastomeric element 85 is fixed at a free end of the second arm 96. A radially outer surface 84 of the elastomeric element 85 includes a radial elevation 86, which fixes the first rigid part 34 to the cup 14 in a frictionally engaged manner. The elevation 86 has a shape of a ring and abuts against the first arm 36. Moreover, the elastomeric element 85 includes a nose 87, which protrudes radially inwardly and which is located in a groove 88 formed by and between the cup 14 and the second rigid part 89. Due to being located in the groove 88, the nose 87 causes a form-fit fixation of the elastomeric element 85 to the rigid part 89 and the cup 14.

A further sealing lip 97 of the elastomeric element 90 abuts against the intermediate part 40. A lip 98 of the elastomeric element 90 extends radially inwardly toward the trunnion 12, but doesn't touch or contact the trunnion 12. When the first rigid part 34 is assembled to the cup 14, the first arm 36 can strike against or contact a radially extending surface of the cup 14. Such contact by the first arm 36 prevents excessive deformation of the sealing lip 97.

The trunnion 12 includes, in an axial region 56 of the seal 18, only two surface regions 58, 60, which each have a shape of a circular cylindrical barrel.

A spring washer 99 of the universal joint bearing 10 abuts against the second rigid part 89 and exerts an axial pressure on the rolling elements 16. The amount of this axial pressure is constant, since the rigid part 89 doesn't deform over a period of time. Alternatively, a shim may replace the spring washer 99. In a further alternative embodiment, the universal joint bearing 10 does not include either the spring washer or a shim.

The cup 14 includes a bottom 46 with a first elevation 52 and a second elevation 54. The row 26 of the rolling elements 16 is disposed directly adjacent to the bottom 46. The row 26 comprises rolling elements 16, which directly contact the first and the second elevations 52, 54 of the bottom 46. The bottom 46 also includes a recess 48, into which the trunnion 12 extends. Each one of the rolling elements 26 has a running surface 50 with an axial extension, the entire axial extension of the running surface 50 being in contact with the trunnion 12. In order to provide room for the recess 48, an axially outer surface of the bottom 46 comprises an elevation, which rises away from the trunnion 12.

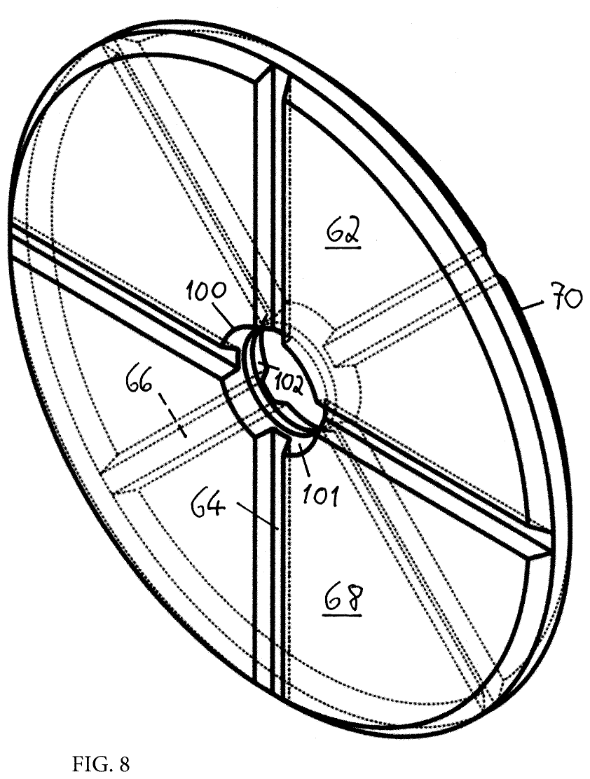

Moreover, the universal joint bearing 10 further comprises a disk 62, which is located between a face side or end face of the trunnion 12 and a part of the bottom 46 of the cup 14. The disk 62 includes a plurality, for example four (as illustrated), grooves 64, 66 on each of its opposing sides 68, 70 (FIG. 8) and a central through hole 100. Each one of the grooves 64,66 starts at the central through hole 100 and extends to a radially outer edge of the disk 62. The through hole 100 has a taper 101, 102 on each end, each taper 101, 102 having an opening angle of about 50°. A lubricant (not shown) is preferably located within each one of the grooves 64, 66.

During an oscillation of the cup 14 relative to the trunnion 12, the disk 62 can move relative to the cup 14 and also relative to the trunnion 12, which reduces total wear and therefore the probability of failure. Preferably, the lubricant is grease and the material of the disk 62 is a glass fiber reinforced polyamide. During assembly, the disk 62 is installed on the bottom 46 of the cup 14 and then grease is injected through the through hole 100 of the disk 82 and into the grooves 66, which face the bottom 46. The grooves 64, 66 preferably have a depth of 0.6 mm. Furthermore, between each one of the grooves 64, there is an angle of 90°. Similarly, between each of the grooves 66, there is an angle of 90°. Moreover, the grooves 64 are rotated by 45° relative to the grooves 66. As a result, the disk 62 has a high stability.

The universal joint cross 72 comprises a cruciform component 74, which includes the trunnion 12. Twice the distance between the center of mass 76 of all the rolling elements 16 of the universal joint bearing 10 and the center of mass 78 of the cruciform component 74 divided by the maximum outer diameter 80 of the cup 14 is less than 2.23 and greater than 1.8. Moreover, the dynamic carrying capacity of the universal joint bearing 10 divided by twice the distance between the center of mass 76 of all the rolling elements 16 of the universal joint bearing 10 and the center of mass 78 of the cruciform component 74 is greater than 0.6 kN/mm and less than 0.9 kN/mm.

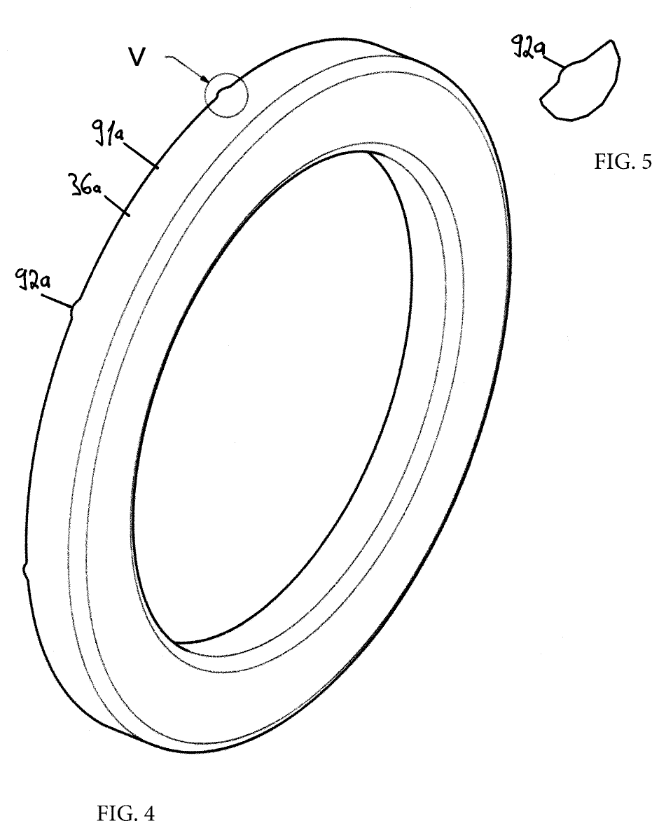

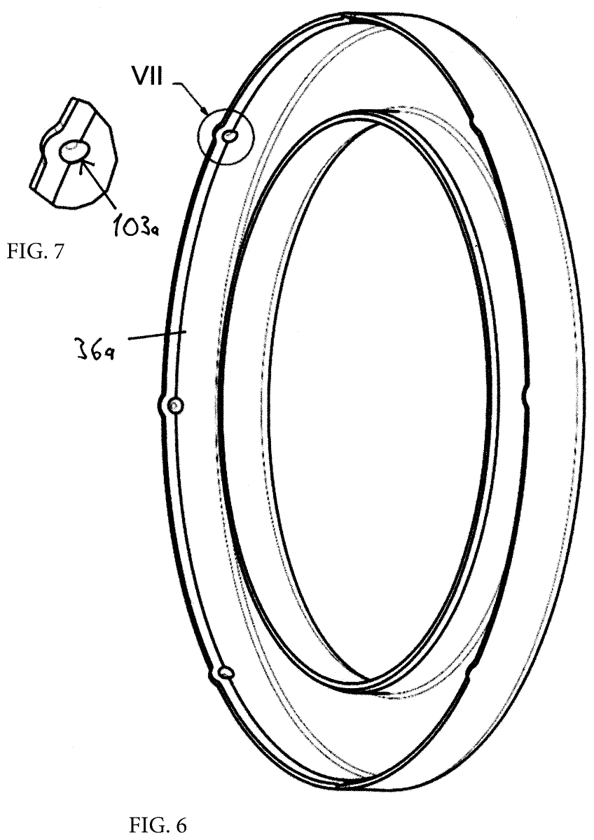

FIGS. 4 to 6 show an alternative embodiment of the first arm 36 of the first rigid part 34 of the seal 18, denoted as the first arm 36a. The first arm 36a differs from the first arm 36 only in the following: the first arm 36a has a free end 91a with elevations 92a in an axial direction 93 of the trunnion 12. Each of the elevations 92a is produced by pushing a stamp at a radially inner location 103a of the free end 91a and deforming the free end 91a through this means. Due to this deformation, material of the free end 91a moves axially outwardly such that the elevations 92a are created.

FIG. 1 shows the universal joint cross 72, which comprises also a conventional universal joint bearing 104. A universal joint cross, which only differs from the universal joint cross 72 in that all four universal joint bearings are identical in construction with the universal joint bearing 10, realizes a further advantage: it has a smaller circumference 106 than the cross 72, which has a circumference 105. Since the maximum force that can be applied to the universal joint bearing 10 is also greater than the maximum force that can be applied to a conventional universal joint bearing, the power density of the cross with the circumference 106 is greater than the power density of a universal joint cross, which only comprises conventional universal joint bearings. The maximum outer diameter of the universal joint bearing 104 and the maximum outer diameter of the universal joint bearing 10 are the same. The circumference 106 is about 15% less than the circumference 105. At the cross with the circumference 105, a lever of an applied force is greater than at a cross with the circumference 106, which means that more material is needed for a cross with the circumference 105 and the assembly requires consequently more space in the vehicle design.

Preferably, the rolling elements 26 are needles.

Alternatively, the universal joint bearing 10 can include a plurality of rows of the rolling elements 26.

The seal 18 is robust and a cassette seal.

During assembly, the rigid part 34 of the seal 18 is fixed to the cup 14, centered relative to the cup 14 and pre-positioned with the help of the elastomeric element 85. This facilitates safe mounting of the rigid part 34 on the trunnion 12. Since the rigid part 34, also called a “flinger”, does not have an elastomeric part fixed to it, costs are saved. Through the fixation of the flinger 34 to the cup 14, the rigid part/flinger 34 is safely in position during handling, transport and final customer assembly before the trunnion 12 is fixed to it. The elevation 86 centers the rigid part/flinger 34 relative to the lip 42 and facilitates the assembly of the seal 18.

During assembly, the first arm 36 of the rigid part/flinger 34 may push against a part of a step 107 of the cup 14, which prevents movement of the arm 36 relative to the cup 14 and also prevents further deformation of the lip 97, thereby protecting the lip 97.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

List of reference numerals:

| | |
|---|---|
| 10 | universal joint bearing |
| 12 | Trunnion |
| 14 | Cup |
| 16 | rolling element |
| 18 | Sealing |
| 20 | Space |
| 22 | Surface |
| 24 | Surface |
| 26 | Row |
| 28 | Length |
| 30 | Sum |
| 32 | Surface |
| 34 | rigid part |
| 36 | first arm |
| 38 | second arm |
| 40 | intermediate part |
| 42 | sealing lip |
| 44 | Surface |
| 46 | Bottom |
| 48 | Recess |
| 50 | running surface |
| 52 | Elevation |
| 54 | Elevation |
| 56 | Region |
| 58 | surface region |
| 60 | surface region |
| 62 | Disc |
| 64 | Groove |
| 66 | Groove |
| 68 | Side |
| 70 | Side |
| 72 | universal joint cross |
| 74 | component |
| 76 | center of mass |
| 78 | center of mass |
| 80 | Diameter |
| 82 | Part |
| 83 | Part |
| 84 | Surface |
| 85 | elastomeric element |
| 86 | Elevation |
| 87 | Nose |
| 88 | Groove |
| 89 | rigid part |
| 90 | elastomeric element |
| 91 | End |
| 92 | Elevation |
| 93 | axial direction |
| 94 | intermediate part |
| 95 | first arm |
| 96 | second arm |
| 97 | sealing lip |
| 98 | Lip |
| 99 | spring washer |
| 100 | Hole |
| 101 | Taper |
| 102 | Taper |
| 103 | Location |
| 104 | universal joint bearing |
| 105 | circumference |
| 106 | Circumference |
| 107 | Step |

We claim:

1. A universal joint bearing comprising:
a trunnion;
a cup having a substantially cylindrical surface, the substantially cylindrical surface providing a part of a radially outer surface of the universal joint bearing;
a plurality of rolling elements rotatably supporting the cup relative to the trunnion and arranged in a number of rows; and
at least one seal configured to seal a space between the trunnion and the cup, the seal having a radially outer surface providing another part of the radially outer surface of the universal joint bearing;
wherein a sum of the maximum axial lengths of all of the rows of rolling element divided by the sum of the maximum axial length of the substantially cylindrical surface of the cup and the maximum axial length of the radially outer surface of the at least one seal is between 0.6 and 0.75.

2. The universal joint bearing according to claim 1, wherein a first rigid part of the seal includes, in an axial section, a first arm, a second arm, and an intermediate part connecting the first arm and the second arm, wherein the first arm and the second arm extend from the intermediate part and toward the rolling elements.

3. The universal joint bearing according to claim 2, wherein a sealing lip of the seal abuts against a radially outer surface of the second arm.

4. The universal joint bearing according to claim 1, wherein:
the cup includes a bottom with a recess and the trunnion extends into the recess; and
the plurality of rolling elements includes a first row of the rolling elements directly adjacent to the bottom of the cup, the first row of rolling elements including at least one rolling element with a running surface having an axial extension, the entire axial extension of the running surface being in contact with the trunnion.

5. The universal joint bearing according claim 1, wherein:
the cup includes a bottom with a first elevation and at least one second elevation; and
the plurality of rolling elements includes a row of the rolling elements directly adjacent to the bottom of the cup, the rolling elements directly contacting the first elevation and the second elevation.

6. The universal joint bearing according to claim 1, wherein the trunnion includes, in an axial region of the seal, at most two surface regions, each surface region having a shape of a circular cylindrical barrel.

7. The universal joint bearing according to claim 1, wherein:
the cup includes a bottom; and
the universal joint bearing further comprises a disk located between the trunnion and at least a part of the bottom of the cup and having two opposing sides and grooves on each of the two opposing sides.

8. A universal joint cross comprising a universal joint bearing according to claim 1.

9. The universal joint cross according to claim 8, wherein:
the universal joint cross further comprises a cruciform component, the cruciform component including the trunnion; and
twice the distance between a center of mass of all the rolling elements of the universal joint bearing and a center of mass of the cruciform component divided by a maximum outer diameter of the cup is less than 2.23 and greater than 1.8.

10. The universal joint cross according to claim 8, wherein:
the universal joint cross further comprises a cruciform component, the cruciform component including the trunnion; and
the dynamic carrying capacity of the universal joint bearing divided by twice the distance between a center of mass of all the rolling elements of the universal joint bearing and the center of mass of the cruciform component is greater than 0.6 kN/mm and less than 0.9 kN/mm.
